(19) United States
(12) Patent Application Publication
(10) Pub. No.: US 2007/0300300 A1
(43) Pub. Date: Dec. 27, 2007

(54) Statistical instrusion detection using log files

(75) Inventors: Jinhong K. Guo, West Windsor, NJ (US); Stephen L. Johnson, Erdenheim, PA (US); Il-Pyung Park, Princeton Junction, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/475,537

(22) Filed: Jun. 27, 2006

(51) Int. Cl. G06F 12/14; G06F 11/00; G06F 12/16; G06F 15/18; G08B 23/00

(52) U.S. Cl. 726/23

(57) ABSTRACT

An intrusion detection system includes a computer readable datastore containing a double Markov model for modeling events in system log files of a computer system by looking at multiple log files and correlations among different log files. An intrusion detection module performs intrusion detection by using the double Markov model to assess probability that a new event is an intrusion, including routinely scanning the system logging data and processing the data periodically. A countermeasures module takes countermeasures when an intrusion is detected.

### FIELD

The present disclosure generally relates to intrusion detection, and relates in particular to statistical intrusion detection using log files.

### BACKGROUND

The statements in this section merely provide background information related to the present disclosure and may not constitute prior art.

Computer security has become a crucial issue in people's daily lives. New strains of viruses and worms are being developed at a fast pace. Malicious, self-propagating executables such as worms as well as attacks like denial-of-service attacks are real threats to computer systems. These malicious intrusions can attack and debilitate a system at such a fast pace that serious harm can be done before the system administrator detects any abnormality of the system. The sooner a worm can be contained in a system, the less harm it is to the overall system on the same network. However, today's virus scan software can only catch a virus after it's initial emergence. There is always a temporal gap between the virus or worm starting to spread and the update of the virus definition in the scanning software. It is critical to catch the malicious intruder as early as possible to prevent it from spreading over the entire network. Thus, automatic intrusion detection is needed.

### SUMMARY

An intrusion detection system includes a computer readable datastore containing a double Markov model for modeling events in system log files of a computer system by looking at multiple log files and correlations among different log files. An intrusion detection module performs intrusion detection by using the double Markov model to assess probability that a new event is an intrusion, including routinely scanning the system logging data and processing the data periodically. A countermeasures module takes countermeasures when an intrusion is detected.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram illustrating an intrusion detection system employing a double Markov model to recognize intrusion patterns based on events recorded in log files of a computer system.

FIG. 2 is a state diagram illustrating a double Markov model for recognizing an intrusion pattern of system activities recorded in system log files and grouped into events.

FIG. 3 is a flow diagram illustrating an intrusion detection method employing a double Markov model to recognize intrusion patterns based on events recorded in log files of a computer system.

### DETAILED DESCRIPTION

The following description is merely exemplary in nature and is not intended to limit the present disclosure, application, or uses.

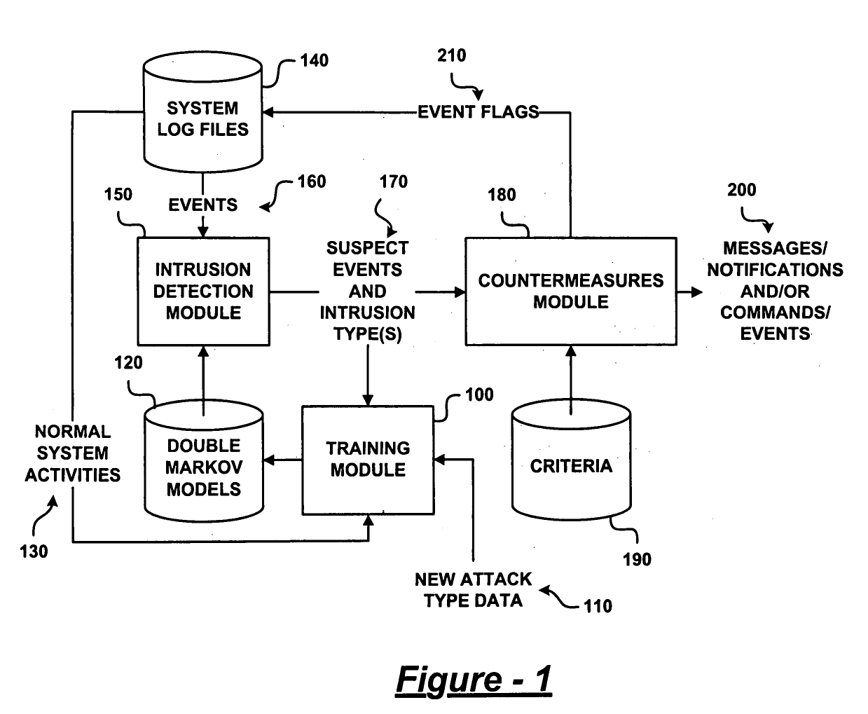

Starting with FIG. 1, a novel intrusion detection system is aimed at detecting any system abnormalities that indicate a potential break-in of the system. The innovative technique utilizes a double Markov model 120 for statistically modeling the activities in a system. The system logging data 140 is routinely scanned and processed periodically by intrusion detection module 150, which groups recorded system activities into events 160 based on time stamps. Once an abnormality is detected, security countermeasures can be taken by countermeasures module 180. For example, the system administrator can be notified. The system administrator can then verify the result and isolate the affected system immediately. Alternatively or additionally, the system can be configured such that, once a potential abnormality is detected; the system isolates itself from the network and the system administer can start working on the recovery of the system. Thus, countermeasures module 180 can issue messages/notification and/or commands/events, such as messages/notifications for notifying the system administrator, and/or commands/events to automatically isolate the computer system from a network. Alternatively or additionally, countermeasures module can flag 210 suspect events identified at 170 by intrusion detection module 160 in system logging data 140 for examination by the system administrator. In some embodiments, the countermeasures taken can be in accordance with criteria 190, which can be defined by a system administrator.

An advantage of this innovative technique is that it uses a statistical model for the system operation. This model can learn from available training data 110 used by training module 100 to establish the model. It can also be trained once more training data, such as suspect events and intrusion types 170, becomes available. It can further be continuously trained with additional data to adapt itself towards any migration of the normal system activities 130.

Additionally, the technique can be applied to different types of logged data. It can also be applied to port scanning to analyze network activities. It further applies to operating system security as well as network security issues.

As mentioned above, this innovative technique can detect abnormal operations by using the system log files. The system log utilities record all the system and network activities. Any individual system activities such as opening a new session can look benign. However, a combination of seemingly harmless activities can imply a malicious attack. These attacks generally follow certain patterns, especially known attacks. Due to the large quantities of system log data, a statistical model can be used. In other words, the system activities can be modeled using a Markov model of a log file based on the fact that the current event mainly depends on the event that just happened. For example, if an attacker just failed to gain access to the system, he is likely to try again. Additionally, there is a correlation among the different log files in the system. Research has illustrated that different attacks have a distinctive pattern in how they show up in different log files. This insight provides us with another dimension that can be modeled statistically. For example, if an event belongs to one specific attack, the probability that the event is recorded in file B is high given it is recorded in file A.

The parameters of the Markov process and the correlation among the different log files can be determined using the standard training techniques using available log data. The Markov model, also termed a double Markov chain or double Markov process, represents known or generalized attack scenarios. Based on the pre-trained parameters and the observation sequence obtained from various log files under examination, the probability of an attack occurring given this observation sequence is calculated. If this probability is high, an attack is suspected.

In case of an intrusion notification by this system, the system administrator can review in detail the flagged log data and decide if the system should be isolated from other machines on the network. For maximum security, the system should take itself off the network before notifying the system administrator.

The intrusion detection approach according the various embodiments can be advantageous over previous approaches in one or more of several ways. For example, some embodiments of the present approach can look at multiple log files and the correlation among the different log files. Thus, some embodiments of the present approach can yield a double Markov chain. Also, some embodiments of the present approach can look for an intrusion directly. In other words, the transitional, initial and conditional probabilities can be trained using abnormal activities. Even though new viruses constantly emerge, they normally bear a striking resemblance at least in some of the activities when reflected by system call level logging. Thus, this new model can reflect the typical behavior of an intrusion. Additionally, the model can be retrained every time a new intrusion is detected. Further, some embodiments of the present approach can perform initial state identification as pre-processing by using the time stamp in the log files. For any events that are separated by a large time interval, it is possible to consider them as separate sequences of operations. Additionally or alternatively, it is possible to screen the events by looking for the possible initial state, such as a login or port scanning, to filter out the most obvious normal activities and decrease the overhead on the system. Finally, some embodiments of the present approach can consider that the frequency of one single operation, such as repeated login and port scanning in a very short time, indicates possible intrusions. Thus, it is possible to utilize this consideration as part of a pre-processing procedure.

The statistical model takes advantage of the fact that the system log files record all the activities in a computer system. This record includes the entire login, network activities, etc. Statistical methods can be used to model the system activities. In particular, a double Markov chain can be used to model the system activities via the system log files. Using this statistical model, it is possible to detect the abnormalities in a system on the fly.

Regarding the Markov model, a statistical process X is a Markov process, if and only if the probability

P(Xₙ₊₁|X₀,X₁, . . . ,Xₙ)=P(Xₙ₊₁|Xₙ)

i.e., the probability of Xₙ₊₁'s occurring depends only on Xₙ.

Markov modeling of log data takes advantage of the fact that the system activities have the Markovian property. For example, the likelihood of a user login after system boot up is much greater than any other activity. Each specific event, e.g., login, contains system operations that relate to each other, particularly the current operation and the one right after. These operations form a Markov chain. Similarly, in the event of an attack, the activities can also be considered as a Markov chain. An attacker will likely to do port scanning. Once he manages to gain access to a machine, he will try to set up an account, possibly with superuser privilege, and open a backdoor for future use.

There are multiple log files associated with a system. Each of these log files monitors the related activities in the system. While one of the log files logs the system activity in one aspect, there is normally at least one of the rest log files records some activity to one specific interest. For example, /var/log/messages logs all the system activities in Linux kernel; /var/log/boot.log only logs the booting activities. The relationship of these log files in regards to one specific event can be considered as a Markov chain.

Let us denote an event as Λ, O as the observation sequence. The probability of seeing the observation sequence O given the event Λ is,

P(O|Λ)=P(O₁₁O₁₂ . . . O₁ₙ_{₁}|Λ)·P₁₂·P(O₂₁O₂₂ . . . O₂ₙ_{₂}|Λ)· . . . ·Pₘ_{^{−}}_{1,m}P(Oₘ₁Oₘ₂ . . . O_{m,n}_{ₘ}|Λ)

Where n₁, n₂, . . . nₘ are the number of operations recoded in the log files while m is the number of log files P₁₂, . . . Pₘ_{^{−}}_{1,m} are the transitional probabilities from one log file to the next log file. Additionally,

P(Oᵢ₁Oᵢ₂ . . . O_{i,n}_{ᵢ})=P(Oᵢ₁)P(Oᵢ₂|Oᵢ₁) . . . P(O_{i,n}_{ᵢ}|O_{i,n}_{_{i−1}})

### Where i=1, 2, . . . , m

The observation sequence consists of the system operations associated with each event. In each log file, different events can be segmented using the time stamp associated with each system operation. If the two consecutive operations happen within a small interval of time, these operations are considered to belong to the same event. If there is a considerable temporal gap between two consecutive operations, these two operations belong to different events. The first operation marks the ending of the event. The characteristic of normal users and intruders is that the normal user has access to and familiarity with the system, and thus works in a more relaxed manner. On the other hand, the intruder needs access to the system and works in an unfamiliar environment. The intruder also needs to work quickly in order to avoid detection. Thus, the system operations should be closely spaced temporally.

In terms of training, the aim is to detect intrusions as soon as possible. Training is performed on known abnormal system log data. These log files are parsed according to the time stamp information as just discussed. In our model, the transitional probabilities between different log files need to be estimated using the log files. Within each log file, the conditional probabilities of the next operation given an operation need to be calculated as well as the initial probability of P(Oi1). When additional data is available, even after the Markov model is established, retraining or modification can be made to the model.

Pre-processing can be performed based on an initial state of the observation sequence. The observation sequence is obtained by grouping the system operations by the time stamps. If two consecutive system operations are separated by a larger time interval, we consider these two operations belong to two separate events. The initial state of the observation sequence is the first system operation that starts a new event.

Possible intrusions normally start with limited variety of system operations. A pre-processing can be implemented to eliminate the events that are highly unlikely to be intrusions. This pre-processing can greatly reduce the overhead to the system. One or more trained Markov models can be used for this purpose. Any zero initial possibility can be interpreted as an indication of that system call is unlikely to start an intrusion.

In some embodiments, pre-processing can also be based on the frequency of one operation. For example, a repeated operation condensed in time can be an indication of possible intrusions. In particular, a repeated failed login or a reported port scanning can indicate some malicious events. This behavior can be caught up with the Markov model. However, since it is easier to distinguish, screening the repeated malicious pattern as part of a pre-processing can reduce the overhead to the system.

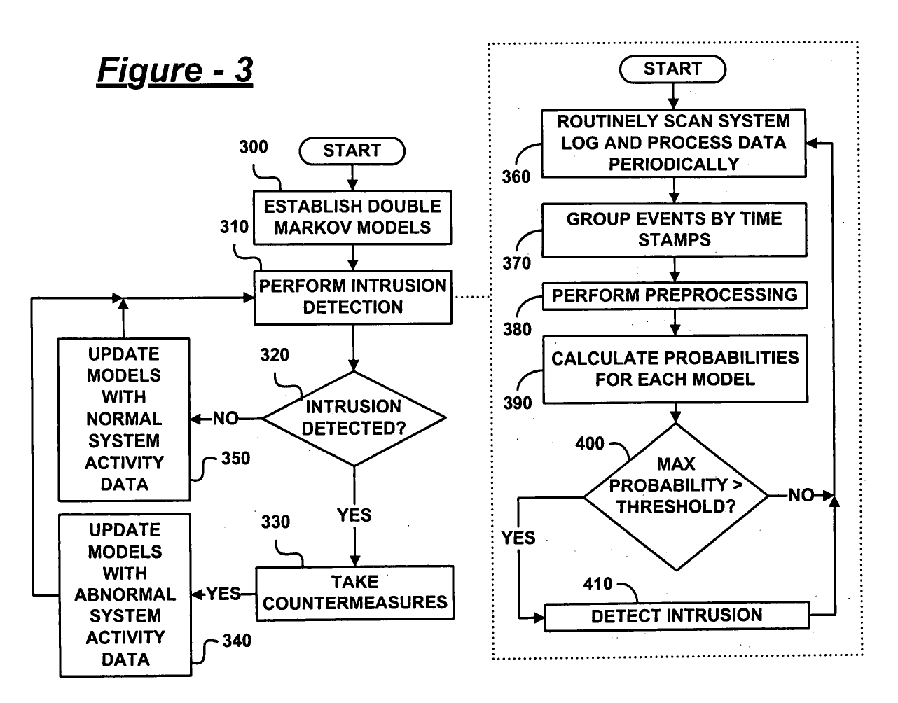

Turning now to FIG. 3, an intrusion detection method begins with establishing the double Markov models at step 300. We have discussed establishing a double Markov model for modeling the events in system logs. For each event, a model can be generated. Since this is performed off-line, it will not affect any system performance. It should be readily understood that models can be generated for individual systems, or can be generated for general systems and provided to end users for use with their systems. It should also be readily understood that a general model can then be adapted to particular end user systems during use.

Given one or more initial models, intrusion detection can then be performed at step 310. For example, the system log is routinely scanned and data processed periodically at step 360. Events are grouped by time stamps at step 370. Preprocessing is performed at step 380 to reduce system overhead. For each new system event that is under examination after the models have been established, the conditional probabilities P(O|Λⱼ), j=1, 2, . . . N, where N is the number of Markov models, are calculated at step 390. The maximum of P(O|Λⱼ), j=1, 2, . . . , N is examined at decision step 400. If this probability is over some threshold, we consider this event to belong to the specific model, possibly a known attack. If the event is classified as one of the known attacks, immediate protection steps are taken at step 330 while notifying the system administrator. Once a new event or a new attack is identified, new training for the model can be performed at step 340 to enable the system to automatically detect and protect from the new attack scenario. If desired, models can also be updated for normal system activity at step 350 when an intrusion is not detected.

There are common features associated with most attacks. For example, the attacker performs port scanning on multiple ports consecutively. This activity is recorded in system log files such as /var/log/messages as well as the network log files. In practice, the conditional probability of an intruder performing a port scan given a previous port scan operation is reasonably larger than a port scan followed by other operations. Also, the transitional probability from the /var/log/messages to the network log is also reasonably high in this case. For a typical Trojan virus, the operations can be summarized as the following: the attacker remotely gains root privilege; the attacker creates an account with superuser privilege; sessions are opened for the newly created account; ftp an attack toolkit from another system.

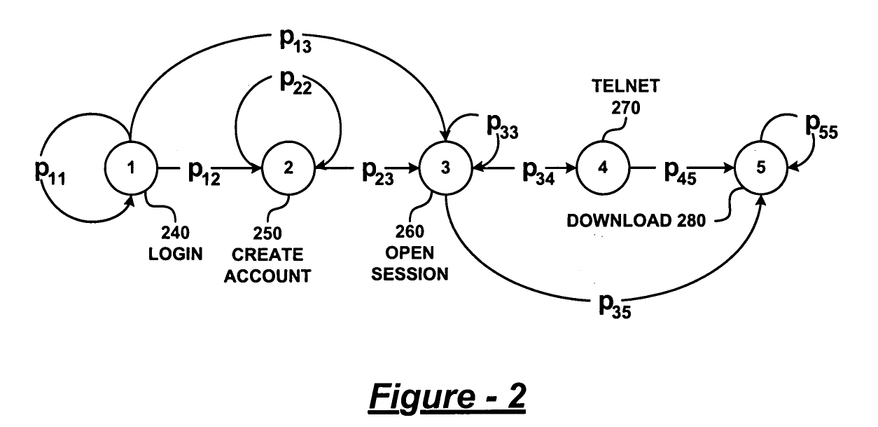

A typical Markov model for the system log file such as /var/log/messages is illustrated in FIG. 2. Therein, system operations, such as login operation 240, create account operation 250, open session operation 260, telnet operation 270, and download operation 280, correspond to states of the model, and the operations/states are connected by edges p₁₁, p₁₂, p₁₃, p₂₂, p₂₃, p₃₃, p₃₄, p₃₅, p₄₅, and p₅₅ representing probabilities of traversal from one operation/state to another. To further illustrate, assume we have an observation sequence O₁₁,O₁₂ . . . O₁ₙ_{₁}=1,1,1,1,2,3,5. Thus, the length of the observation sequence n₁=7. Furthermore, the attacker tried four times to login as root, then created a new account, opened a new session, and eventually downloaded the executables from a remote server. The probability of intrusion given the observation sequence O₁₁,O₁₂ . . . O₁ₙ_{₁} and modeled Trojan attack is P(O₁₁O₁₂ . . . O₁ₙ_{₁}|Λ)=P(O₁₁)×p₁₁×p₁₁×p₁₁×p₁₂×p₂₃×p₃₅ where P(O₁₁) is the probability of the attack beginning with a login effect.

These activities are recorded in one or more log files. The above example illustrates the Markov model for one log file; similar models can be obtained for all the different log files. The relationships among the different log files are represented using the set of probabilities P₁₂, . . . Pₘ_{^{−}}_{1,m}.

As we have discussed earlier, the high correlation between the operations and the log files can be modeled using a Markov process. Using known attack data, we can train a Markov model for this scenario. With the trained model, log files are segmented using time stamp information or by predetermined window sizes. This segmented group of operations is then passed to the model to see if it fits the model. If the probability of belonging to the attack model is high, the system administrator is notified.

In conclusion, the proposed technique utilizes the Markov model as the statistical model in modeling a running computer system. This model can be updated as more training data becomes available. It can be applied to various system logging data and use these data to detect any abnormality in a running system. Once a potential problem is identified, the system administer can be notified. The administrator can decide if the system needs to be isolated from the network. The system can also be configured such that if a potential problem is found, it will automatically be taken off-line to prevent further damage to the overall system.

The same algorithm applies to various data. One such example can be the port activity data obtained from routine porting scanning. Using the port data, potential break-ins can be detected before it causes severe damage to the entire network. When applying this algorithm to other computer data, only the observation sequence needs to be defined accordingly, as to reflect the characteristics of that specific application.

It should be readily understood that various embodiments the intrusion detection technique can be combined in various ways. For example, one way embodiments of the intrusion detection technique can be combined is to take different countermeasures based on dangerousness of a recognized attack pattern and/or a level of confidence with which an attack pattern is recognized. In such cases, the system can take itself offline if a dangerous attack pattern is recognized with a high degree of probability exceeding a first threshold selected to reflect near certainty that the attack is taking place. Yet, the system can merely flag suspect log data and notify the administrator if the degree of probability falls below the first threshold but above a second threshold selected to reflect mere possibility that the attack is taking place. Moreover, it is possible that a less dangerous attack can have the maximum probability, while a more dangerous attack can still have a sufficient probability to warrant countermeasures. In this case, there is a lack of confidence that a particular attack is taking place, but the countermeasures can still be applied based on either or both of the attack patterns being recognized. For example, the system can be taken offline, the suspect log data flagged, and the system administrator notified that both types of attacks are possible. It is envisioned that the countermeasures taken and the criteria for taking the countermeasures can be specified by the system administrator. Moreover, if the routine benign behavior repeatedly trips a possible intrusion, the system administrator's negative feedback that no intrusion took place can be used to retrain the double markov model.

What is claimed is:

1. An intrusion detection system, comprising:
a computer readable datastore containing a double Markov model for modeling events in system log files of a computer system by looking at multiple log files and correlations among different log files;
an intrusion detection module performing intrusion detection by using the double Markov model to assess probability that a new event is an intrusion, including routinely scanning the system logging data and processing the data periodically; and
a countermeasures module taking countermeasures when an intrusion is detected.

2. The system of claim 1, wherein said intrusion detection module groups system operations into events by time stamps recorded on the operations in the system log files, wherein if two consecutive system operations are separated by a time interval above a threshold, these two operations are considered to belong to two separate events.

3. The system of claim 1, wherein said intrusion detection module performs pre-processing to reduce overhead on the computer system.

4. The system of claim 3, wherein said intrusion detection module performs the preprocessing by eliminating events that are highly unlikely to be intrusions.

5. The system of claim 3, wherein said intrusion detection module performs the preprocessing by screening for a repeated operation condensed in time as an indication of a possible intrusion.

6. The system of claim 1, further comprising a training module updating the double Markov model based on the new event upon detection of an intrusion.

7. The system of claim 1, further comprising a training module continuously training the double Markov model with additional data to adapt the model towards any migration of the normal system activities.

8. The system of claim 1, wherein said countermeasures module takes the countermeasures by notifying the system administrator.

9. The system of claim 1, wherein said countermeasures module takes the countermeasures by flagging suspect log data for evaluation by the system administrator.

10. The system of claim 1, wherein said countermeasures module takes the countermeasures by causing the computer system to isolate itself from a network so that the system administer can start working on recovery of the computer system.

11. An intrusion detection method, comprising:
establishing a double Markov model for modeling events in system log files of a computer system by looking at multiple log files and correlations among different log files;
performing intrusion detection by using the double Markov model to assess probability that a new event is an intrusion, including routinely scanning the system logging data and processing the data periodically; and
taking countermeasures when an intrusion is detected.

12. The method of claim 11, further comprising grouping system operations into events by time stamps recorded on the operations in the system log files, wherein if two consecutive system operations are separated by a time interval above a threshold, these two operations are considered to belong to two separate events.

13. The method of claim 11, further comprising performing pre-processing to reduce overhead on the computer system.

14. The method of claim 13, wherein performing the preprocessing includes eliminating events that are highly unlikely to be intrusions.

15. The method of claim 13, wherein performing the preprocessing includes screening for a repeated operation condensed in time as an indication of a possible intrusion.

16. The method of claim 11, further comprising updating the double Markov model based on the new event upon detection of an intrusion.

17. The method of claim 11, further comprising continuously training the double Markov model with additional data to adapt the model towards any migration of the normal system activities.

18. The method of claim 11, wherein taking the countermeasures includes notifying the system administrator.

19. The method of claim 11, wherein taking the countermeasures includes flagging suspect log data for evaluation by the system administrator.

20. The method of claim 11, wherein taking the countermeasures includes causing the computer system to isolate itself from a network so that the system administer can start working on recovery of the computer system.
